(19) United States
(12) Patent Application Publication
(10) Pub. No.: US 2026/0147716 A1
(43) Pub. Date: May 28, 2026

(54) TECHNIQUES TO IMPLEMENT A DATA-AWARE CACHE REPLACEMENT POLICY

(71) Applicant: Intel Corporation, Santa Clara, CA (US)

(72) Inventors: Keqiang WU, Palatine, IL (US); Adrian C. MOGA, Portland, OR (US); Yuan ZHOU, Shanghai (CN); Krishnaswamy VISWANATHAN, Portland, OR (US); Christopher J. HUGHES, Santa Clara, CA (US)

(21) Appl. No.: 19/122,676

(22) PCT Filed: Dec. 22, 2022
(86) PCT No.: PCT/CN2022/141012

§ 371 Date: Apr. 18, 2025

(51) Int. Cl. G06F 12/126; G06F 12/0897; G06F 12/123

(52) U.S. Cl. CPC G06F 12/126; G06F 12/0897; G06F 12/123

(57) ABSTRACT

Examples include techniques to implement a data-aware cache replacement policy. The techniques include indicating, to a cache controller, that data to be included in a cache line is likely to be reused. The indication of likely-to-be-reused data is to be used by the cache controller to determine when the data is to be evicted or replaced in the cache.

### TECHNICAL FIELD

Examples described herein are generally related to techniques associated with a cache replacement policy for a processor cache.

### BACKGROUND

Central processing unit (CPU) performance can often be enhanced or improved by increasing level 2 (L) or level 3 (L3) cache capacities that are utilized by one or more processing cores of the CPU. CPU vendors, such as Intel® Corporation, AMD®, or ARM® have consistently increased L2 or L3 cache capacities to improve performance of successive CPU generations. For example, Intel's Xeon Cascade Lake CPUs can have an L2 capacity of 1 megabyte (MB) and an L3 capacity of 1.375 MB, yet a succussive Xeon CPU generation known as Sapphire Rapids® can have an L2 capacity of 2 MB and an L3 capacity of 1.87 MB. Also, AMD's Genoa® EPYC® CPUs can have an L2 capacity of 1 MB, yet a successive EPYC CPU generation known as Milan® has an L2 cache capacity of 2 MB. ARM CPU generations show a similar trend compared to Intel and AMD for increasing L2 or L3 cache capacities for successive CPU generations. This enlarge-cache-capacity approach has typically been effective and efficient to improve generation-to-generation performance for many workloads executed by CPUs. For example, workloads executed by CPUs deployed in a data center. In some examples, workloads executed by CPUs deployed in a data center can support business intelligence and analytics applications associated with big data such as online transaction processing (OLTP) and online analytical processing (OLAP) applications.

### BRIEF DESCRIPTION OF THE DRAWINGS

FIG. 1 illustrates an example computing platform.

FIG. 2 illustrates an example first hash join scheme.

FIG. 3 illustrates an example second hash join scheme.

FIG. 4 illustrates an example first code.

FIG. 5 illustrates example second code.

FIG. 6 illustrates an example comparison of cache replacement policies.

FIG. 7 illustrates an example flow for a cache replacement policy.

FIG. 8 illustrates examples of computing hardware to process a MOVREUSE instruction.

FIG. 9 illustrates an example method performed by a processor to process a MOVREUSE instruction.

FIG. 10 illustrates an example method to process a MOVREUSE instruction using emulation or binary translation.

FIG. 11 illustrates an example computing system.

FIG. 12 illustrates a block diagram of an example processor and/or System on a Chip (SoC) that may have one or more cores and an integrated memory controller.

FIG. 13A is a block diagram illustrating both an example in-order pipeline and an example register renaming, out-of-order issue/execution pipeline according to examples.

FIG. 13B is a block diagram illustrating both an example in-order architecture core and an example register renaming, out-of-order issue/execution architecture core to be included in a processor according to examples.

FIG. 14 illustrates examples of execution unit(s) circuitry.

FIG. 15 is a block diagram of a register architecture according to some examples.

FIG. 16 illustrates examples of an instruction format.

FIG. 17 illustrates examples of an addressing information field.

FIG. 18 illustrates examples of a first prefix.

FIGS. 19(A)-(D) illustrate examples of how the R, X, and B fields of the first prefix in FIG. 18 are used.

FIGS. 20(A)-(B) illustrate examples of a second prefix.

FIG. 21 illustrates examples of a third prefix.

FIG. 22 is a block diagram illustrating the use of a software instruction converter to convert binary instructions in a source instruction set architecture to binary instructions in a target instruction set architecture according to examples.

### DETAILED DESCRIPTION

Workloads executed by CPUs such as workloads associated with OLTP or OLAP applications may demonstrate markedly different cache use behaviors. For example, OLTP applications (e.g., HammerDB, TPC-C, etc.) are typically frontend bound and initially load large amounts of data to a processor cache for executing an OLTP workload. However, OLAP applications (e.g., TPC-DS, TPC-H, etc.) are typically backend bound and initially load smaller amounts of data to a processor cache (e.g., L2/L3 cache) followed by larger amounts of data for executing an OLAP workload. As a result of these markedly different cache use behaviors, an OLAP workload's processor cache miss pattern can be very different compared to an OLTP workload's processor cache miss pattern.

Increases in processor cache capacities that are typical for successive CPU generations has been shown to improve performance for OLTP workloads. However, OLAP workloads compared to OLTP workloads typically have a little or a limited performance gain due to increased processor cache capacities. This little or limited performance gain can be attributed to processor cache miss patterns for OLAP workloads that are backend bound, as mentioned above. As described below, example techniques are provided that can enable big data OLAP applications to benefit and/or increase performance gains when a processor cache capacity is increased, example techniques are not limited to use with just OLAP applications. Example techniques include a novel data-aware cache replacement policy with software assistance. Software assistance in the form of hints, for example, can enable a cache controller of a processor cache to differentiate likely-to-be-reused data from other data placed in a cache line. The likely-to-be reused data can be assigned a higher priority that causes the likely-to-be-reused data placed in the cache line to have an extended stay in a processor cache when choosing what cache line data to evict or replace in a processor cache. The extended stay for the likely-to-be-reused data, for example, can improve or amplify performance gains of backend bound workloads such as OLAP workloads when processor cache capacities are increased.

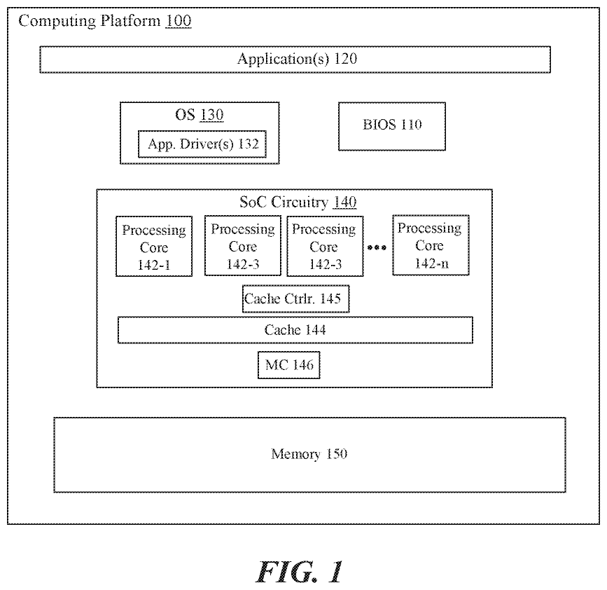

FIG. 1 illustrates an example computing platform 100. According to some examples, as shown in FIG. 1, computing platform 100 includes a basic input/output system (BIOS) 110, one or more application(s) 120, an operating system (OS) 130, system-on-chip (SoC) circuitry 140, or memory 150. BIOS 110, for example, can be arranged as a Unified Extensible Firmware Interface (UEFI) BIOS. For these examples, computing platform 100 can include, but is not limited to, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof.

In some examples, OS 130 is shown in FIG. 1 as including one or more application driver(s) 132. Also, as shown in FIG. 1, SoC circuitry 140 includes processing cores 142-1 to 142-n, where “n’ is any positive whole integer greater than 1. Processing cores 142-1 to 142-n may include various commercially available processors, including without limitation an AMD® Zen®; ARM® application processor embedded and secure processors; Qualcomm® Snapdragon® processors; Intel® Atom®, Core i3, Core i5, Core i7, Xeon® or Xeon Phi® processors; and similar processors. Also, as shown in FIG. 1, SoC circuitry 140 includes a cache controller 145 to manage and/or control access to a cache 144 and a memory controller (MC) 146 to manage and/or control assess to memory 150. For example, to move data between cache 144 and memory 150. As described more below, an application driver from among application driver(s) 132 can assist or facilitate a type of software assistance to enable cache controller 145 to differentiate likely-to-be-reused data from other data placed in cache lines to be stored to cache 144. For example, the application driver may use a new LOAD instruction that serve as a hint to indicate to cache controller 145 whether data placed in a cache line to be stored in cache 144 is likely to be reused. Cache controller 145 can then use these hints that refer to data reuse to implement a data-aware cache replacement policy that extends or prolongs an amount of time likely-to-be-reused data for a given cache line stored to cache 144 is maintained in cache 144 before being evicted or replaced with other data.

While various examples described herein could use System-on-a-Chip or System-on-Chip (“SoC”) to describe a device or system having a processor and associated circuitry (e.g., I/O circuitry, processing cores, power delivery circuitry, memory controller circuitry, memory circuitry, etc.) integrated monolithically into a single integrated circuit (“IC”) die, or chip, the present disclosure is not limited in that respect. For example, in various examples of the present disclosure, a device, computing platform or computing system could have one or more processors (e.g., one or more processor cores) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Memory 150 can include volatile and/or non-volatile types of memory. In some examples, Memory 150 includes one or more dual in-line memory modules (DIMMs) that are arranged to include any combination of volatile or non-volatile memory. For these examples, the volatile and/or non-volatile memory included in memory 150 may operate in compliance with a number of memory technologies described in various standards or specifications, such as DDR3 (DDR version 3), JESD79-3F, originally released by JEDEC (Joint Electronic Device Engineering Council) in July 2012, DDR4 (DDR version 4), JESD79-4C, originally published in January 2020, DDR5 (DDR version 5), JESD79-5B originally published in September 2022, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published by in June 2021), WIO2 (Wide Input/output version 2), JESD229-2 originally published in August 2014, HBM (High Bandwidth Memory), JESD235, originally published in October 2013, HBM2 (HBM version 2), JESD235C, originally published in January 2020, or HBM3 (HBM version 3), JESD238, originally published in January 2022, or other memory technologies or combinations of memory technologies, as well as technologies based on derivatives or extensions of such above-mentioned specifications. The JEDEC standards or specifications are available at www.jedec.org.

According to some examples, as mentioned above, memory 150 can include various types of volatile and/or non-volatile memory. Volatile types of memory may include, but are not limited to, dynamic random access memory (DRAM), static random access memory (SRAM), thyristor RAM (TRAM) or zero-capacitor RAM (ZRAM). Non-volatile types of memory may include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above.

Although not shown in FIG. 1, computing platform 100 may include additional components that facilitate the operation of computing platform 100. For example, various network and/or internal communication interfaces and associated interconnects can communicatively couple the elements shown in FIG. 1 to each other or to elements on other computing platforms.

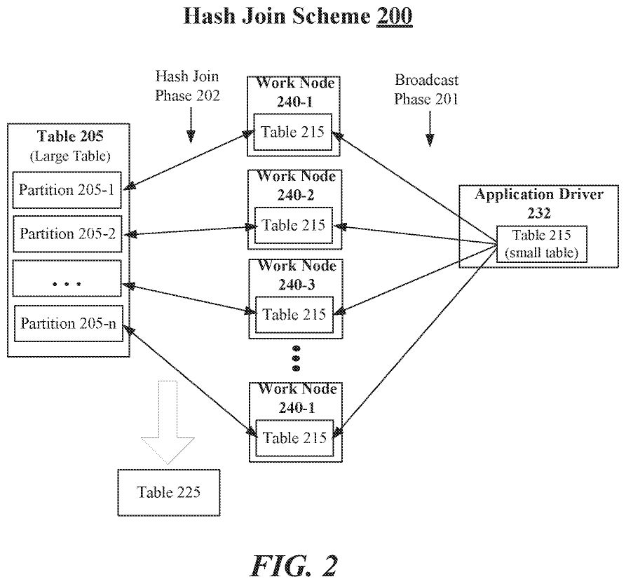

FIG. 2 illustrates an example hash join scheme 200. In some examples, hash join scheme 200 shown in FIG. 2 is a type of join operation commonly referred to as BroadcastHashjoin (BHJ). Hash join scheme 200, as shown in FIG. 2, includes an application driver 232 and a plurality of execution or work nodes 240-1 to 240-n. Work nodes 240-1 to 240-n can be, for example, separate processing cores such as processing cores 142-1 to 142-n shown in FIG. 1. According to some examples, as shown in FIG. 2, the BHJ operation depicted by hash join scheme 200 works by application driver 232 broadcasting a small dataset included in table 215 (small table) to all work nodes 240-1 to 240-n during broadcast phase 201. For these examples, following broadcast phase 201, a standard hash join is performed by each work node of work nodes 240-1 to 240n at hash join phase 202. In hash join phase 202, the small dataset included in table 215 is hashed in all work nodes 240-1 to 240-n and separately joined with a respective partition of a big dataset included in table 205 (large table) to generate a combined dataset to be included in table 225. For example, table 215 is hashed by work nodes 240-1, 240-2, 240-3 and 250-n and then separately joined with respective partitions 205-1, 205-2, 205-3 and 205-n of table 205 to generate a combined dataset included in table 225.

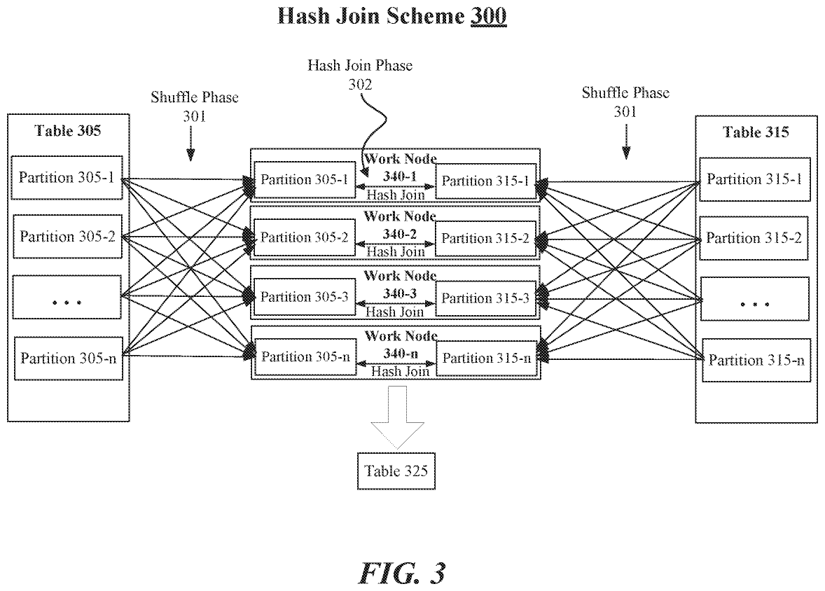

FIG. 3 illustrates an example hash join scheme 300. In some examples, hash join scheme 300 shown in FIG. 3 is a type of join operation commonly referred to as ShuffledHashJoin (SHJ). Hash join scheme 300 includes moving data included in tables 305 and 315 with a same value of join key in a same executor or work node from among work nodes 340-1 to 340-n. Work nodes 340-1 to 340-n can be, for example, separate processing cores such as processing cores 142-1 to 142-n shown in FIG. 1. For an SHJ join operation such as hash join scheme 300, at shuffle phase 301, a join condition is used as an output key, partition data 305-1 to 305-n included in table 305 and partitioned data 315-1 to 315-n included in table 315 are shuffled amongst work nodes 340-1 to 340-n. Then, at hash join phase 302, data is combined by each work node from among work nodes 340-1 to 340-n to generate a combined data set included in table 325.

The three most common join operation implementations include BHJ, SHJ and SortMergeJoin (SMJ). As mentioned above for BHJ and SHJ operations depicted by respective hash join schemes 200 and 300, join operations combine data from two or more tables to obtain required information for analysis and reporting such as, but not limited to, OLAP application workloads. Join operations can be considered a fundamental operation in big data analytics software, which is designed to extract insight from a wide range of large data sources. Among the three most common join operation implementations of BHJ, SHJ and SMJ, SMJ requires that the join keys are sortable and SMJ's performance is poor compared to BHJ's or SHJ's performance. As a result, SMJ is less popular or even unsupported in some popular distributed SQL query engines for big data. BHJ and SHJ are generally recognized as the most widely used and preferred join operation implementations for open-source software such as, but not limited to, Apache Spark™, especially when associated with queries requiring low latency. Also, besides open-source software, a similar preference for BHJ or SHJ has been observed for cloud service providers (CSPs) such as ByteDance or Baidu for big data analytics.

According to some examples, implementation of hash join schemes 200 and 300 for BHJ and SHJ are similar. This implementation can be performed by an application driver (e.g., from among application driver(s) 132) first creating a hash table based on a join_key or smaller relation (i.e., small table) and then looping the larger relation (i.e., large table) to match the hashed join-key values. For example, the smaller relation refers to table 215 shown in FIG. 2 for hash join scheme 200 (BHJ) and refers to partitions 315-1 to 315-n from table 315 shown in FIG. 3 for the hash join scheme 300 (SHJ). Meanwhile, for this example, the larger relation refers to table 205 shown in FIG. 2 for hash join scheme 200 (BHJ) and refers to table 305 shown in FIG. 3 for hash join scheme 300 (SHJ).

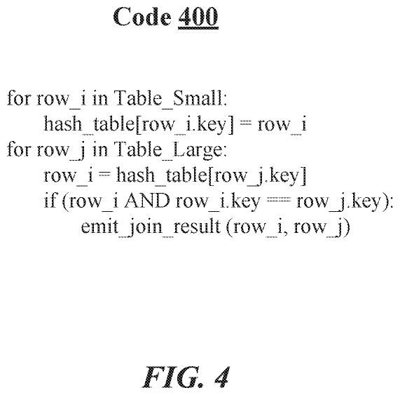

FIG. 4 illustrates an example code 400. According to some examples, code 400 shown in FIG. 4 is an example pseudo-code of a hash join implementation. For these examples, “emit_join_result” combines entries on multiple tables into one table as depicted in FIGS. 2-3 for hash join schemes 200 and 300. In general, “emit_join_result” is not limited to combine table entries together. In some examples, a join operation can carry some payload in a result which will be used in following operators. Thus, a table payload size can be one factor causing caching pollution in cache lines saved to a processor cache (e.g., cache 114). For more complex scenarios, besides to compare join-keys values, some other condition checks can be required before an “emit_join_result” is generated using code 400. Under such circumstances, not only the keys but also some other table payloads need to be fetched into the processor cache. These complex scenarios are not uncommon. For example, some ad-hoc queries handled by content provider platforms can often show a complicated syntax and behavior.

According to some examples, if there is little to no interference or cache pollution when implementing a hash join operation such as implementing a BHJ operation for OLAP workloads, a benefit/improved performance can occur from use of large processor caches when executing the OLAP workload. For example, a hash table containing “Table_Small” (e.g., smaller relation) can see re-use in each iteration of code 400, and a larger processor cache should hold more entries of the hash table. Theoretically, the enlarged processor cache should lead to better performance and a lower miss per instruction (MPI). However, an OLAP workload's often complex characteristics (e.g., streaming effect from large table scanning, pollution from table payload, noise from other concurrent operations, etc.) oftentimes pollutes the processor cache. The polluted processor cache can result in cache lines included hash table entries being evicted too eagerly and requiring data for the hash table entries to be obtained from system memory rather than keeping this data in the processor cache. As a result, cache capacity benefits associated with increasing processor cache capacities can be diminished for OLAP workloads. As briefly mentioned above, and described more below, a novel data-aware cache replacement policy with software assistance can enable a cache controller of a processor cache to differentiate likely-to-be-reused data from other data placed in a cache line to extend an amount of time that identified likely-to-be-reused data can remain in the processor cache before being evicted to gain back at least some cache capacity benefits associated with increasing processor cache capacities.

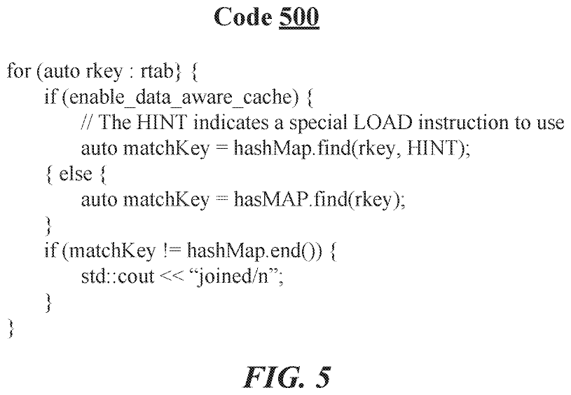

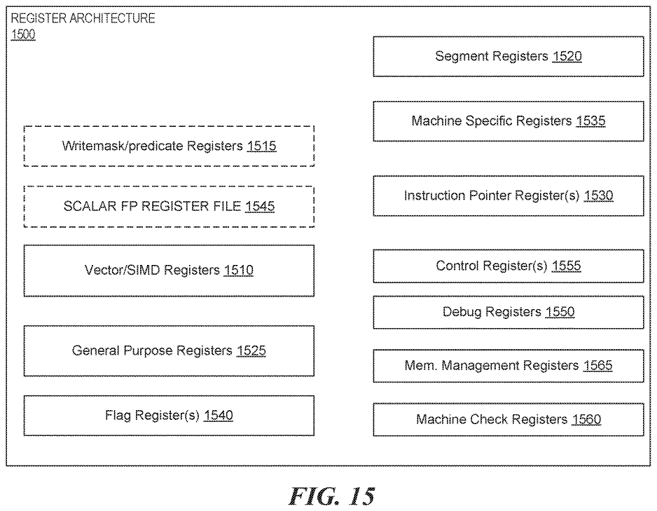

FIG. 5 illustrates an example code 500. According to some examples, code 500 shown in FIG. 5 is an example pseudo-code associated with software assistance and a hash join operation to indicate via a “HINT” or lack of a “HINT” whether or not data loaded to a cache line of a processor cache for a hash join operation includes likely-to-be-reused data. As shown in FIG. 5, “The HINT indicates a special LOAD to use” for a cache controller to add an indication of a priority to the likely-to-be-reused data so that the likely-to-be-reused data can have an extended stay in the processor cache before being replaced or evicted from the processor cache. If the HINT is not provided, the cache controller does not attach or indicate a priority to data in a cache line for that hash join operation. In some examples, the HINT is provided as a prefix to the special LOAD instruction such as prefix 1601 described in FIG. 16 below. In some examples, the special LOAD to use may be a new instruction set architecture (ISA) instruction identified as MOVREUSE (move data w/reuse). For these examples, the special LOAD MOVREUSE acts as the “HINT” to indicate that data to be loaded to a cache line is likely-to-be-reused data.

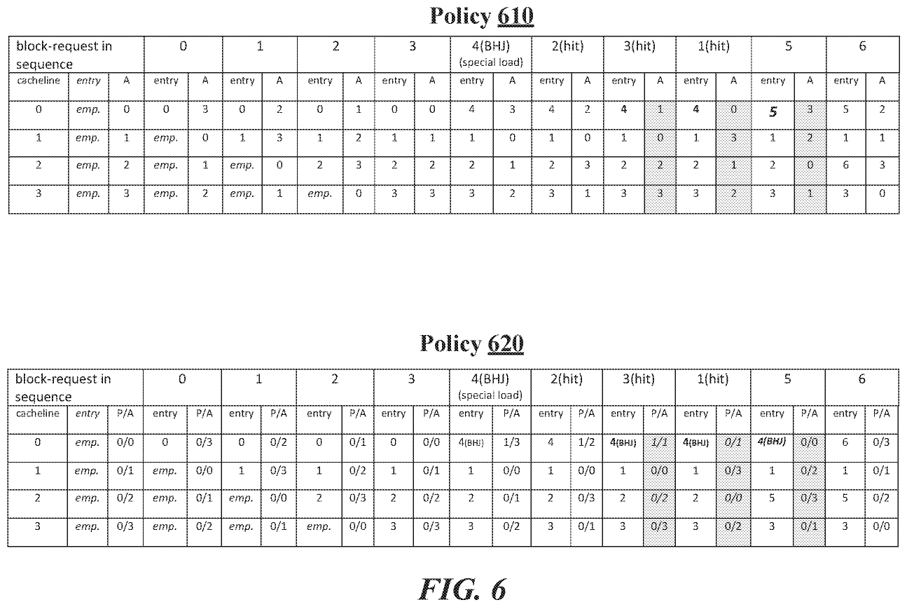

FIG. 6 illustrates an example comparison of cache replacement policy 610 to cache replacement policy 620. According to some examples, policy 610 and policy 620 are both based on a least recently used (LRU) cache replacement policy that includes use of an age bit “A” to indicate how long a cache line entry is included in a cache compared to other cache line entries and to keep track of order of access. For simplicity, a 4-way associative cache is used for both policy 610 and policy 620 and similar block-request sequences of <0, 1, 2, 3, 4 (from special LOAD for BHJ), 2, 3, 1, 5, 6>. For these examples, policy 610 indicates implementation of a typical LRU policy for which a cache controller evicts or replaces a data entry for a cache line for which the age bit=0. For example, as shown in FIG. 6, for policy 610, cache line 0's entry of “0” is eventually aged to have an age bit=0 by time of block-request in sequence of “4” (BHJ) and according to policy 601 the cache line 0 entry of “0” is replaced with an entry of “4”.

In some examples, policy 620 shows an enhanced data-aware cache replacement policy that includes use of at least one additional bit to indicate priority information (examples not limited to a 1-bit priority indication). For normal or regular loads of data/entries to a cache line (e.g., no special LOAD instruction or other hint of likely data reuse), on a cache miss, the priority bit of P/A for that cache line is cleared (e.g., set to 0). Then on a cache hit with a normal or regular load, the priority bit of P/A is left unchanged (e.g., stays 0 if already 0, and stays 1 if already 1). Responsive to a special LOAD instruction (e.g., MOVREUSE), a cache controller sets the priority bit of P/A (e.g., set to value of 1) for the cache line that is identified by the special LOAD instruction as including likely-to-be-reused data to be included in the entry to the cache line. The priority bit of P/A is set to 1 regardless of whether the entry to that cache line is a cache miss or cache hit.

According to some examples, as shown in FIG. 6 for policy 620, 2 bits for P/A can be used by a cache controller to indicate a priority and to indicate an age of an entry maintained in a cache line. The data-ware cache replacement policy of policy 620 includes the priority bit being set to 1 when a cache line entry is loaded with a special LOAD instruction (e.g., MOVREUSE). A cache controller can be configured to only replace cache lines with both priority bit=0 and age bit=0. If a cache line entry with age bit=1 and a priority bit=1 is detected by the cache controller (even on a cache hit), the cache controller can be configured to reduce the priority bit by 1. As a result, priority bit=0 and the age bit is not changed and thus the entry in that cache line loses its priority, but is saved from being the next entry of a cache line to be evicted or replaced. Only changing the priority bit and not changing the age bit keeps data in an entry of a cache line with a higher priority in the cache longer. Keeping the entry of the cache line longer in the cache allows for more opportunities to reuse the entry, without needing to pin the prioritized data in the cache.

The data-aware cache replacement policy 620 is not limited to using LRU implementations. A pseudo-LRU implementation is also contemplated and frequency-based cache replacement implementations/algorithms are also contemplated. Also, as mentioned previously, the number of priority bits are not limited to 1. In other words, the number of priority bits can strike a balance based on software characteristics and hardware costs associated with supporting multiple priority bits. For example, multiple bits will consume more cache line capacity and add complexity. Also, examples are not limited to the 4-way associative cache described above for FIG. 6.

The data-aware cache replacement policy 620 mentioned above utilizes a priority bit to give data in a cache line entry a one-time (unless it is touched again with a special LOAD instruction) get-out-of-jail-free card. In other words, data in that prioritized cache line entry is skipped over from becoming the next replacement victim. Alternative examples are contemplated, for example, including having an entry for a cache line losing its priority but having its age bit reset to a value corresponding to the most-recently-used cache line (e.g., increase age bit value from 0 to 3), to give the entry even longer life in the cache before being replaced or evicted.

In some examples, a processor (e.g., that includes processing cores 142) may include decoder circuitry to decode a special LOAD instruction (e.g. MOVREUSE). The decoded special LOAD instruction to provide a temporal locality hint (e.g., to a cache controller) for a cache line to prevent eviction of data maintained in the cache line for at least one cache line eviction event due to a cache line miss. The cache line to be prevented from eviction for the at least one cache line eviction event without needing to pin the data to the cache line.

According to some examples, the data-aware cache replacement policy 620, by having a priority bit cleared as a cache line entry is about to become the next entry to be evicted, a cache is ensured to not be filled with cache line entries all having their priority bits set. However, if all but one of the cache line entries have a priority bit set when a cache miss occurs, the LRU cache line will be evicted, and then a conundrum results: a need exists to age the existing cache line entries, making one these cache line entries as the new LRU cache line (e.g., next evicted cache line entry), but all cache lines have priority bit sets for their respective entries. In this example, the cache line entry with the “oldest” age bit will have its priority bit cleared and also will have its age bit set to 0 to address this conundrum.

As shown in FIG. 6, the grey-shaded columns for policy 610 and for policy 620 highlight how the two cache replacement policies are different following a special LOAD instruction (e.g., MOVREUSE). In one example, a cache controller and/or the cache is not arranged or configured to use a priority bit to indicate data is likely to be reused following a special LOAD instruction, for example, a special LOAD instruction associated with a BHJ operation as shown at block-request in sequence 4 (BHJ) for policy 610. For this one example, policy 610 is implemented and as shown in FIG. 6 only an age bit is set for entry 4 of cache line 0 when entry 4 is placed in cache line 0. Consequently, entry 4's age bit is decremented following successive hits for other entries for block-request sequences 2, 3, 1 and then cache line 0's entry 4 is evicted based on its age bit reaching zero and replaced with entry 5. In another example, a cache controller and/or the cache is arranged to use both a priority bit and an age bit to indicate data is likely to be reused following a special LOAD instruction (e.g., a MOVREUSE instruction associated with a BHJ operation). For this other example, policy 620 is implemented and as shown in FIG. 6, both a priority bit and an age bit is set for entry 4 of cache line 0 when entry 4 is placed in cache line 0. Consequently, entry 4's age bit is decremented following successive hits for block-request sequences 2, 3, but rather than having the age bit incremented to 0 following block-request 4, only the priority bit is decremented for entry 4 and entry 4's age bit is not decremented. Thus, at block-request 5, entry 4 is not yet evicted from cache line 0, but its age bit is decremented to 0. So as shown in FIG. 6 for policy 610, entry 4 was evicted following block-request 5, but for policy 620 entry 4 was allowed to remain in cache line 0 for at least an additional block-request.

Included herein is a logic flow representative of example methodologies for performing novel aspects of the disclosed techniques for a data-aware cache replacement. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow can be implemented by computer executable instructions stored on at least one non-transitory computer readable medium or machine readable medium, such as an optical, magnetic or semiconductor storage. The examples are not limited in this context.

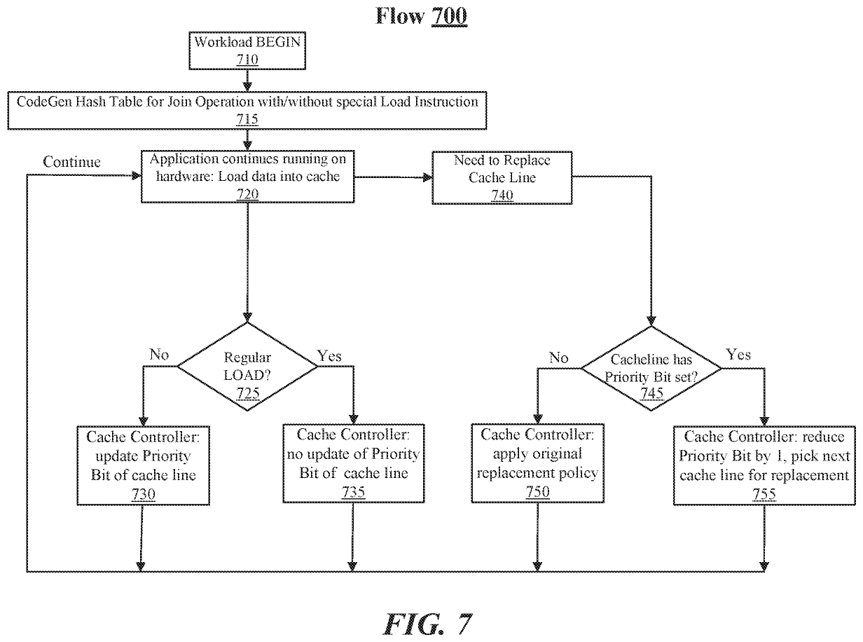

FIG. 7 illustrates an example flow 700. According to some examples, flow 700 can be an example of actions taken by software executed based on an OLAP codebase in coordination with an application driver and a cache controller of a processor cache to enable the cache controller to implement a data-aware cache replacement policy/algorithm. For example, an OLAP application included in application(s) 120 in coordination with an application driver from among application driver(s) 132 and cache controller 145 of cache 144 to enable cache controller 145 at computing platform 100 shown in FIG. 1 to implement policy 620 as shown in FIG. 6 and described above. MC 146, for example, can assist application driver(s) 132 with loading the data from memory 150 to cache lines included in cache 144. Example flow 700 is not limited to these elements of computing platform 100 shown in FIG. 1 or to policy 620 shown in FIG. 6.

In some examples, at 710, a workload begins. For these examples, the workload may be associated with execution of an OLAP application included in applications(s) 120.

According to some examples, at 720, CodeGen associated with the OLAP application executes a Hash Table for a join operation with or without a special LOAD instruction (e.g., MOVREUSE). For these examples, code 400 and code 500 shown in FIGS. 4 and 5 may be at least portions of the CodeGen associated with the OLAP application to execute the Hash Table for a join operation (e.g., a BHJ operation). For these examples, without a special LOAD instruction indicates a regular LOAD that does not include a “HINT” that indicates to a cache controller such as cache controller 145 that the data is not likely to be reused. Also for these examples, with a special LOAD instruction indicates a special LOAD that includes a “HINT” that indicates to the cache controller that the data is likely to be reused.

In some examples, at 720, the application continues running on hardware as data associated with the join operation is loaded into cache. For these examples, data associated with the join operation can be pulled or obtained from memory 150 via MC 146 responsive to requests from an application driver from among application driver(s) 132 for the OLAP application. The obtained data may then be loaded to cache 144.

In some examples, at 725, a determination is made as to whether the data is associated with a regular LOAD. For these examples, if the Hash Table for the join operation was executed with a special LOAD instruction, then the LOAD is not a regular LOAD and flow 700 moves to 730. If the Hash Table for the join operation was executed without a special LOAD instruction, the LOAD is a regular LOAD and flow 700 moves to 735.

According to some examples, at 730, the cache controller updates or sets a priority bit of an entry to the cache line that will store data for the entry to the cache. For these examples, cache controller 145 sets a priority bit for the entry to the cache line to stored data for the entry to cache 144 to indicate that this data is likely to be reused. The priority bit, for example, is set according to policy 620 as described above. Flow 700 then continues from 730 back to 720.

In some examples, at 735, the cache controller does not update or set a priority bit for the entry to the cache line that will store data for the entry to the cache. For these examples, cache controller 145 does not set the priority bit because no indication was provided that the data was likely to be reused.

According to some examples, at 740, the cache controller determines that an entry maintained in a cache line needs to be evicted or replaced (e.g., due to a cache miss). For these examples, cache controller 145 determines that all cache lines have entries/data and due to the cache miss data in at least one of the cache lines needs to be evicted or replaced.

In some examples, the cache controller determines if the entry of the cache line has a priority bit set. For example, if cache controller 145 determines the cache line has an entry to store data in cache 144 that does not have the priority bit set, then flow 700 moves to 750. If cache controller 145 determines that the cache line has an entry to store data in cache 144 that does have a priority bit set, then flow 700 moves to 755.

According to some examples, at 750, the cache controller applies an original replacement policy that relies just on an age bit to determine that the entry included in the cache line is to be evicted or replaced. For example, if the priority bit and the age bit are both set to 0 for this entry of the cache line, then cache controller 145 evicts or replaces the data for the entry in the cache line with newly loaded data. Flow 700 then continues back to 720.

In some examples, at 755, the cache controller reduces the priority bit for the entry of the cache line by 1 (e.g., set to 0), and an entry for another cache line is picked for eviction. For these examples, cache controller 145 sets the priority bit of the entry of the cache line to 0 and another entry of another cache line with the next LRU status is picked to have its data evicted or replaced. Flow 700 then continues back to 720. Flow 700 can then continue as long as data continues to be loaded to the cache in association with execution of a workload for the OLAP application.

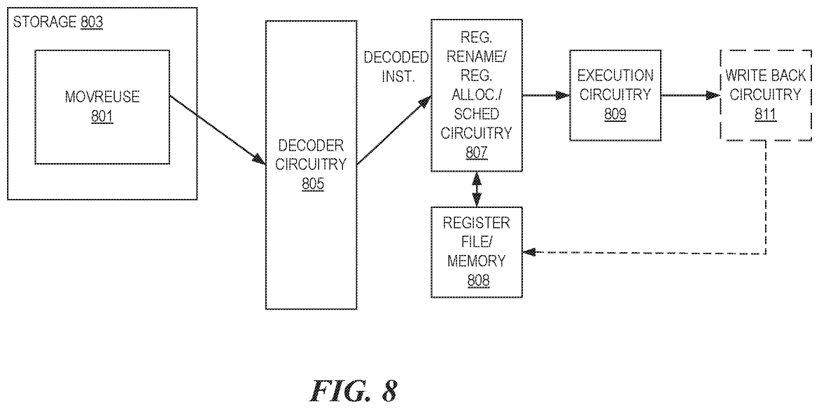

FIG. 8 illustrates examples of computing hardware to process a MOVREUSE instruction. The instruction may be a special load instruction, such as MOVREUSE instruction. As illustrated, storage 803 stores a MOVREUSE instruction 801 to be executed.

The MOVREUSE instruction 801 is received by decoder circuitry 805. For example, the decoder circuitry 805 receives this instruction from fetch circuitry (not shown). The instruction may be in any suitable format, such as that describe with reference to FIG. 16 below. In an example, the instruction includes fields for an opcode, and a destination identifier. In some examples, the sources and destination are registers, and in other examples one or more are memory locations. In some examples, one or more of the sources may be an immediate operand. In some examples, the opcode details an indication to a processor cache controller that data included in a join operation to be added to a cache line stored to processor cache is likely to be reused.

More detailed examples of at least one instruction format for the instruction will be detailed later. The decoder circuitry 805 decodes the instruction into one or more operations. In some examples, this decoding includes generating a plurality of micro-operations to be performed by execution circuitry (such as execution circuitry 809). The decoder circuitry 805 also decodes instruction prefixes.

In some examples, register renaming, register allocation, and/or scheduling circuitry 807 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 808 store data as operands of the instruction to be operated by execution circuitry 809. Example register types include packed data registers, general purpose registers (GPRs), and floating-point registers.

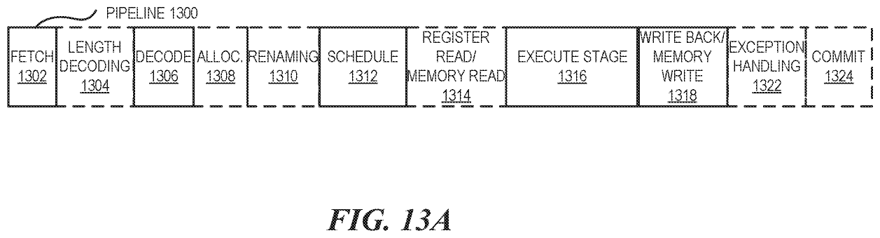

Execution circuitry 809 executes the decoded instruction. Example detailed execution circuitry may be included in a processing core 142 of SoC circuitry 140 shown in FIG. 1, and execution cluster(s) 1360 shown in FIG. 13(B), etc. The execution of the decoded instruction causes the execution circuitry to provide an indication to a processor cache controller that data included in a join operation to be added to a cache line stored to processor cache is likely to be reused.

In some examples, retirement/write back circuitry 811 architecturally commits the destination register into the registers or memory 808 and retires the instruction.

An example of a format for MOVREUSE instruction is OPCODE DST, SRC1, SRC2. In some examples, OPCODE is the opcode mnemonic of the instruction. DST is a field for the destination operand, such as packed data register or memory. SRC1 and SRC2 are fields for the source operands, such as packed data registers and/or memory.

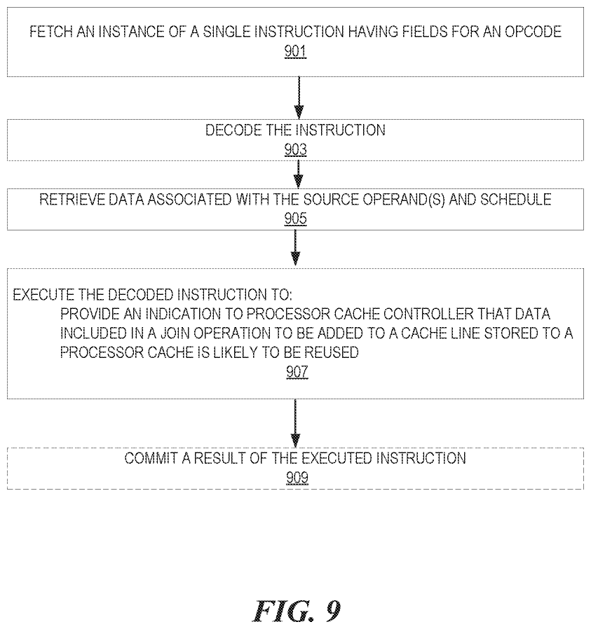

FIG. 9 illustrates an example method performed by a processor to process a MOVREUSE instruction. For example, a processor core as shown in FIG. 13(B), a pipeline as detailed below, etc., performs this method.

At 901, an instance of single instruction is fetched. For example, a MOVREUSE instruction is fetched. The instruction includes fields for an opcode. In some examples, the instruction further includes a field for a writemask. In some examples, the instruction is fetched from an instruction cache. The opcode indicates to a processor cache controller that data included in a join operation to be added to a cache line stored to processor cache is likely to be reused.

The fetched instruction is decoded at 903. For example, the fetched MOVREUSE instruction is decoded by decoder circuitry such as decoder circuitry 805 or decode circuitry 1340 detailed herein.

Data values associated with the source operands of the decoded instruction are retrieved when the decoded instruction is scheduled at 905. For example, when one or more of the source operands are memory operands, the data from the indicated memory location is retrieved.

At 907, the decoded instruction is executed by execution circuitry (hardware) such as execution circuitry included in a processing core 142 of SoC circuitry 140 shown in FIG. 1, execution circuitry 809 shown in FIG. 8, or execution cluster(s) 1360 shown in FIG. 13(B). For the MOVREUSE instruction, the execution will cause execution circuitry to perform the operations.

In some examples, the instruction is committed or retired at 909.

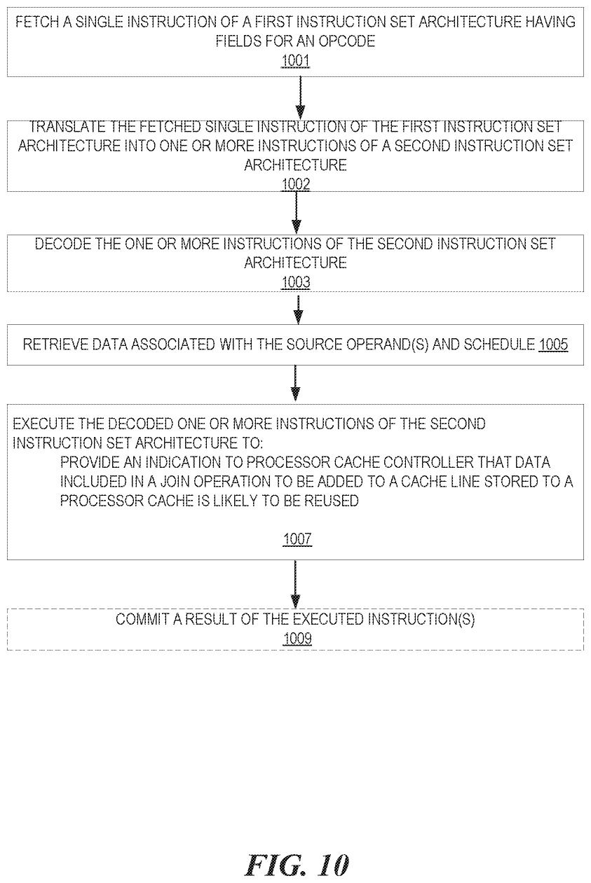

FIG. 10 illustrates an example method to process a MOVREUSE instruction using emulation or binary translation. For example, a processor core as shown in FIG. 13(B), a pipeline and/or emulation/translation layer perform aspects of this method.

An instance of a single instruction of a first instruction set architecture is fetched at 1001. The instance of the single instruction of the first instruction set architecture includes fields for an opcode. In some examples, the instruction further includes a field for a writemask. In some examples, the instruction is fetched from an instruction cache. The opcode to instruct that an indication is to be made to a processor cache controller that data included in a join operation to be added to a cache line stored to processor cache is likely to be reused.

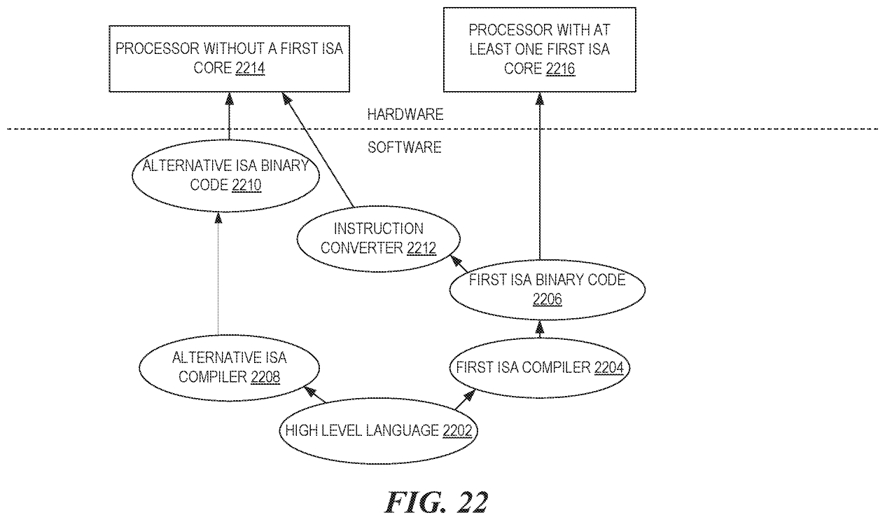

The fetched single instruction of the first instruction set architecture is translated into one or more instructions of a second instruction set architecture at 1002. This translation is performed by a translation and/or emulation layer of software in some examples. In some examples, this translation is performed by an instruction converter 2212 as shown in FIG. 22. In some examples, the translation is performed by hardware translation circuitry.

The one or more translated instructions of the second instruction set architecture are decoded at 1003. For example, the translated instructions are decoded by decoder circuitry such as decoder circuitry 805 or decode circuitry 1340 detailed herein. In some examples, the operations of translation and decoding at 1002 and 1003 are merged.

Data values associated with the source operand(s) of the decoded one or more instructions of the second instruction set architecture are retrieved and the one or more instructions are scheduled at 1005. For example, when one or more of the source operands are memory operands, the data from the indicated memory location is retrieved.

At 1007, the decoded instruction(s) of the second instruction set architecture is/are executed by execution circuitry (hardware) such as execution circuitry execution circuitry 809 shown in FIG. 8, or execution cluster(s) 1360 shown in FIG. 13(B), to perform the operation(s) indicated by the opcode of the single instruction of the first instruction set architecture. For the MOVREUSE instruction, the execution will cause execution circuitry provide an indication to a processor cache controller that data included in a join operation to be added to a cache line stored to a processor cache is likely to be reused.

In some examples, the instruction is committed or retired at 1009.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

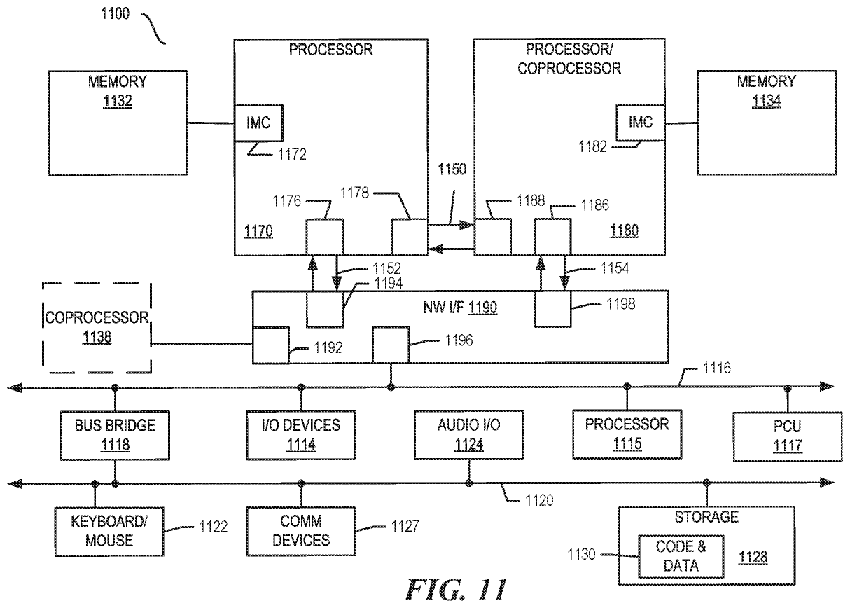

FIG. 11 illustrates an example computing system. Multiprocessor system 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, first processor 1170 and the second processor 1180 are heterogenous. Though the example system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a coprocessor 1138 via an interface circuit 1192. In some examples, the coprocessor 1138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or co-processor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media as described below, such as a disk drive or other mass storage device which may include instructions/code and data 1130 and may implement the storage 803 in some examples. Further, an audio I/O 1124 may be coupled to second interface 1120. Note that other architectures than the point-to-point architecture described above are possible. For example, instead of the point-to-point architecture, a system such as multiprocessor system 1100 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

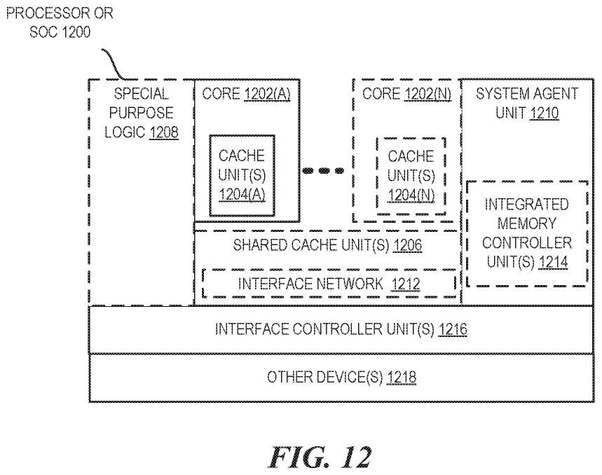

FIG. 12 illustrates a block diagram of an example processor and/or SoC 1200 that may have one or more cores and an integrated memory controller. The solid lined boxes illustrate a processor 1200 with a single core 1202(A), system agent unit circuitry 1210, and a set of one or more interface controller unit(s) circuitry 1216, while the optional addition of the dashed lined boxes illustrates an alternative processor 1200 with multiple cores 1202(A)-(N), a set of one or more integrated memory controller unit(s) circuitry 1214 in the system agent unit circuitry 1210, and special purpose logic 1208, as well as a set of one or more interface controller units circuitry 1216. Note that the processor 1200 may be one of the processors 1170 or 1180, or co-processor 1138 or 1115 of FIG. 11.

Thus, different implementations of the processor 1200 may include: 1) a CPU with the special purpose logic 1208 being integrated graphics and/or scientific (throughput) logic (which may include one or more cores, not shown), and the cores 1202(A)-(N) being one or more general purpose cores (e.g., general purpose in-order cores, general purpose out-of-order cores, or a combination of the two); 2) a coprocessor with the cores 1202(A)-(N) being a large number of special purpose cores intended primarily for graphics and/or scientific (throughput); and 3) a coprocessor with the cores 1202(A)-(N) being a large number of general purpose in-order cores. Thus, the processor 1200 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1204(A)-(N) within the cores 1202(A)-(N), a set of one or more shared cache unit(s) circuitry 1206, and external memory (not shown) coupled to the set of integrated memory controller unit(s) circuitry 1214. The set of one or more shared cache unit(s) circuitry 1206 may include one or more mid-level caches, such as level 2 (L2), level 3 (L3), level 4 (L4), or other levels of cache, such as a last level cache (LLC), and/or combinations thereof. While in some examples interface network circuitry 1212 (e.g., a ring interconnect) interfaces the special purpose logic 1208 (e.g., integrated graphics logic), the set of shared cache unit(s) circuitry 1206, and the system agent unit circuitry 1210, alternative examples use any number of well-known techniques for interfacing such units. In some examples, coherency is maintained between one or more of the shared cache unit(s) circuitry 1206 and cores 1202(A)-(N). In some examples, interface controller units circuitry 1216 couple the cores 1202 to one or more other devices 1218 such as one or more I/O devices, storage, one or more communication devices (e.g., wireless networking, wired networking, etc.), etc.

In some examples, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous in terms of instruction set architecture (ISA). Alternatively, the cores 1202(A)-(N) may be heterogeneous in terms of ISA; that is, a subset of the cores 1202(A)-(N) may be capable of executing an ISA, while other cores may be capable of executing only a subset of that ISA or another ISA.

Example Core Architectures—in-Order and Out-of-Order Core Block Diagram.

FIG. 13(A) is a block diagram illustrating both an example in-order pipeline and an example register renaming, out-of-order issue/execution pipeline according to examples. FIG. 13(B) is a block diagram illustrating both an example in-order architecture core and an example register renaming, out-of-order issue/execution architecture core to be included in a processor according to examples. The solid lined boxes in FIGS. 13(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13(A), a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1306 and the register read/memory read stage 1314 may be combined into one pipeline stage. In one example, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13(B) may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13(B) shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In one example, the instruction cache circuitry 1334 is included in the memory unit circuitry 1370 rather than the front-end circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In one example, the core 1390 includes a microcode ROM (not shown) or other medium that stores microcode for certain macroinstructions (e.g., in decode circuitry 1340 or otherwise within the front-end circuitry 1330). In one example, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine circuitry 1350.

The execution engine circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In one example, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In one example, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1390 includes logic to support a packed data instruction set architecture extension (e.g., AVX1, AVX2), thereby allowing the operations used by many multimedia applications to be performed using packed data.

### Example Execution Unit(s) Circuitry.

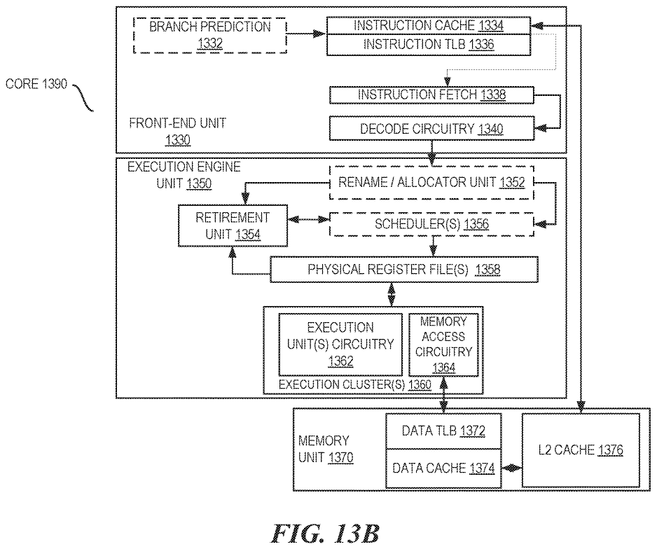

FIG. 14 illustrates examples of execution unit(s) circuitry, such as execution unit(s) circuitry 1362 of FIG. 13(B). As illustrated, execution unit(s) circuitry 1362 may include one or more ALU circuits 1401, optional vector/single instruction multiple data (SIMD) circuits 1403, load/store circuits 1405, branch/jump circuits 1407, and/or Floating-point unit (FPU) circuits 1409. ALU circuits 1401 perform integer arithmetic and/or Boolean operations. Vector/SIMD circuits 1403 perform vector/SIMD operations on packed data (such as SIMD/vector registers). Load/store circuits 1405 execute load and store instructions to load data from memory into registers or store from registers to memory. Load/store circuits 1405 may also generate addresses. Branch/jump circuits 1407 cause a branch or jump to a memory address depending on the instruction. FPU circuits 1409 perform floating-point arithmetic. The width of the execution unit(s) circuitry 1362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

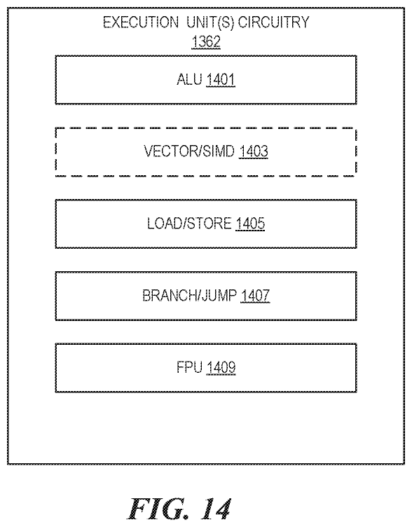

FIG. 15 is a block diagram of a register architecture 1500 according to some examples. As illustrated, the register architecture 1500 includes vector/SIMD registers 1510 that vary from 128-bit to 1,024 bits width. In some examples, the vector/SIMD registers 1510 are physically 512-bits and, depending upon the mapping, only some of the lower bits are used. For example, in some examples, the vector/SIMD registers 1510 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1500 includes writemask/predicate registers 1515. For example, in some examples, there are 8 writemask/predicate registers (sometimes called k0 through k7) that are each 16-bit, 32-bit, 64-bit, or 128-bit in size. Writemask/predicate registers 1515 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1515 corresponds to a data element position of the destination. In other examples, the writemask/predicate registers 1515 are scalable and consists of a set number of enable bits for a given vector element (e.g., 8 enable bits per 64-bit vector element).

The register architecture 1500 includes a plurality of general-purpose registers 1525. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1500 includes scalar floating-point (FP) register file 1545 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1540 (e.g., EFLAGS, RFLAGS, etc.) store status and control information for arithmetic, compare, and system operations. For example, the one or more flag registers 1540 may store condition code information such as carry, parity, auxiliary carry, zero, sign, and overflow. In some examples, the one or more flag registers 1540 are called program status and control registers.

Segment registers 1520 contain segment points for use in accessing memory. In some examples, these registers are referenced by the names CS, DS, SS, ES, FS, and GS.

Machine specific registers (MSRs) 1535 control and report on processor performance. Most MSRs 1535 handle system-related functions and are not accessible to an application program. Machine check registers 1560 consist of control, status, and error reporting MSRs that are used to detect and report on hardware errors.

One or more instruction pointer register(s) 1530 store an instruction pointer value. Control register(s) 1555 (e.g., CR0-CR4) determine the operating mode of a processor (e.g., processor 1170, 1180, 1138, 1115, and/or 1200) and the characteristics of a currently executing task. Debug registers 1550 control and allow for the monitoring of a processor or core's debugging operations.

Memory (mem) management registers 1565 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1500 may, for example, be used in register file/memory 808, or physical register file(s) circuitry 1358.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 16 illustrates examples of an instruction format. As illustrated, an instruction may include multiple components including, but not limited to, one or more fields for: one or more prefixes 1601, an opcode 1603, addressing information 1605 (e.g., register identifiers, memory addressing information, etc.), a displacement value 1607, and/or an immediate value 1609. Note that some instructions utilize some or all the fields of the format whereas others may only use the field for the opcode 1603. In some examples, the order illustrated is the order in which these fields are to be encoded, however, it should be appreciated that in other examples these fields may be encoded in a different order, combined, etc.

The prefix(es) field(s) 1601, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1603 is used to at least partially define the operation to be performed upon a decoding of the instruction. In some examples, a primary opcode encoded in the opcode field 1603 is one, two, or three bytes in length. In other examples, a primary opcode can be a different length. An additional 3-bit opcode field is sometimes encoded in another field.

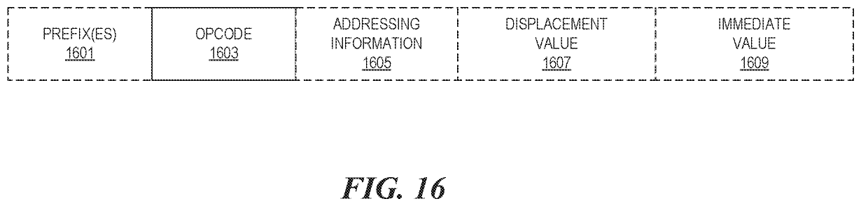

The addressing information field 1605 is used to address one or more operands of the instruction, such as a location in memory or one or more registers. FIG. 17 illustrates examples of the addressing information field 1605. In this illustration, an optional MOD R/M byte 1702 and an optional Scale, Index, Base (SIB) byte 1704 are shown. The MOD R/M byte 1702 and the SIB byte 1704 are used to encode up to two operands of an instruction, each of which is a direct register or effective memory address. Note that both of these fields are optional in that not all instructions include one or more of these fields. The MOD R/M byte 1702 includes a MOD field 1742, a register (reg) field 1744, and R/M field 1746.

The content of the MOD field 1742 distinguishes between memory access and non-memory access modes. In some examples, when the MOD field 1742 has a binary value of 11 (11b), a register-direct addressing mode is utilized, and otherwise a register-indirect addressing mode is used.

The register field 1744 may encode either the destination register operand or a source register operand or may encode an opcode extension and not be used to encode any instruction operand. The content of register field 1744, directly or through address generation, specifies the locations of a source or destination operand (either in a register or in memory). In some examples, the register field 1744 is supplemented with an additional bit from a prefix (e.g., prefix 1601) to allow for greater addressing.

The R/M field 1746 may be used to encode an instruction operand that references a memory address or may be used to encode either the destination register operand or a source register operand. Note the R/M field 1746 may be combined with the MOD field 1742 to dictate an addressing mode in some examples.

The SIB byte 1704 includes a scale field 1752, an index field 1754, and a base field 1756 to be used in the generation of an address. The scale field 1752 indicates a scaling factor. The index field 1754 specifies an index register to use. In some examples, the index field 1754 is supplemented with an additional bit from a prefix (e.g., prefix 1601) to allow for greater addressing. The base field 1756 specifies a base register to use. In some examples, the base field 1756 is supplemented with an additional bit from a prefix (e.g., prefix 1601) to allow for greater addressing. In practice, the content of the scale field 1752 allows for the scaling of the content of the index field 1754 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1607 provides this value. Additionally, in some examples, a displacement factor usage is encoded in the MOD field of the addressing information field 1605 that indicates a compressed displacement scheme for which a displacement value is calculated and stored in the displacement field 1607.

In some examples, the immediate value field 1609 specifies an immediate value for the instruction. An immediate value may be encoded as a 1-byte value, a 2-byte value, a 4-byte value, etc.

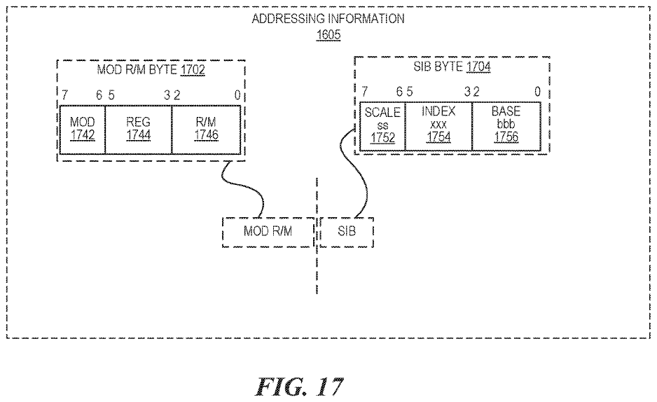

FIG. 18 illustrates examples of a first prefix 1601(A). In some examples, the first prefix 1601(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1601(A) may specify up to three registers using 3-bit fields depending on the format: 1) using the reg field 1744 and the R/M field 1746 of the MOD R/M byte 1702; 2) using the MOD R/M byte 1702 with the SIB byte 1704 including using the reg field 1744 and the base field 1756 and index field 1754; or 3) using the register field of an opcode.

In the first prefix 1601(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1744 and MOD R/M R/M field 1746 alone can each only address 8 registers.

In the first prefix 1601(A), bit position 2 (R) may be an extension of the MOD R/M reg field 1744 and may be used to modify the MOD R/M reg field 1744 when that field encodes a general-purpose register, a 64-bit packed data register (e.g., a SSE register), or a control or debug register. R is ignored when MOD R/M byte 1702 specifies other registers or defines an extended opcode.

Bit position 1 (X) may modify the SIB byte index field 1754.

Bit position 0 (B) may modify the base in the MOD R/M R/M field 1746 or the SIB byte base field 1756; or it may modify the opcode register field used for accessing general purpose registers (e.g., general purpose registers 1525).

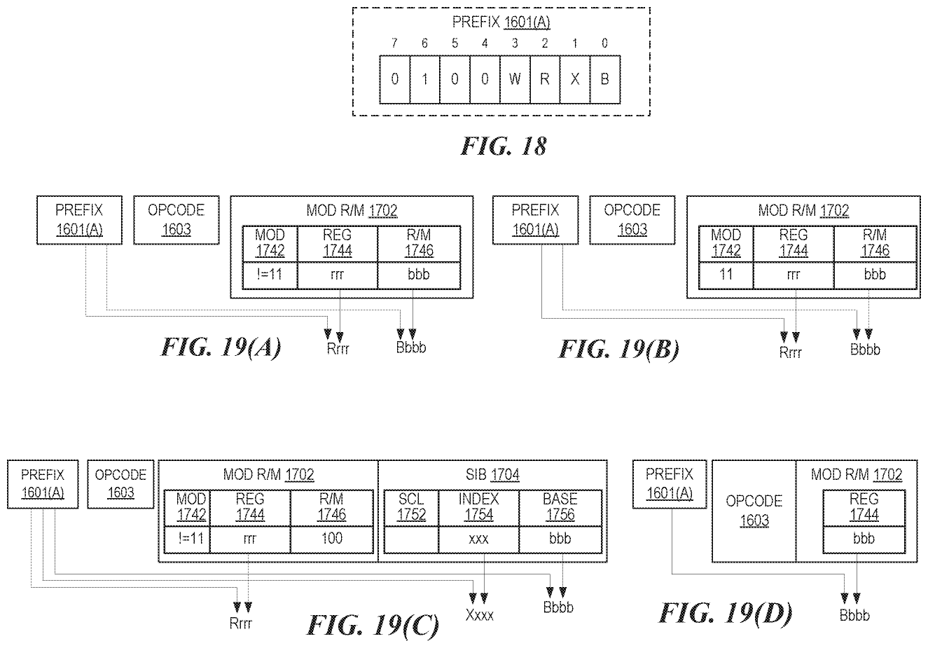

FIGS. 19(A)-(D) illustrate examples of how the R, X, and B fields of the first prefix 1601(A) are used. FIG. 19(A) illustrates R and B from the first prefix 1601(A) being used to extend the reg field 1744 and R/M field 1746 of the MOD R/M byte 1702 when the SIB byte 17 04 is not used for memory addressing. FIG. 19(B) illustrates R and B from the first prefix 1601(A) being used to extend the reg field 1744 and R/M field 1746 of the MOD R/M byte 1702 when the SIB byte 17 04 is not used (register-register addressing). FIG. 19(C) illustrates R, X, and B from the first prefix 1601(A) being used to extend the reg field 1744 of the MOD R/M byte 1702 and the index field 1754 and base field 1756 when the SIB byte 17 04 being used for memory addressing. FIG. 19(D) illustrates B from the first prefix 1601(A) being used to extend the reg field 1744 of the MOD R/M byte 1702 when a register is encoded in the opcode 1603.

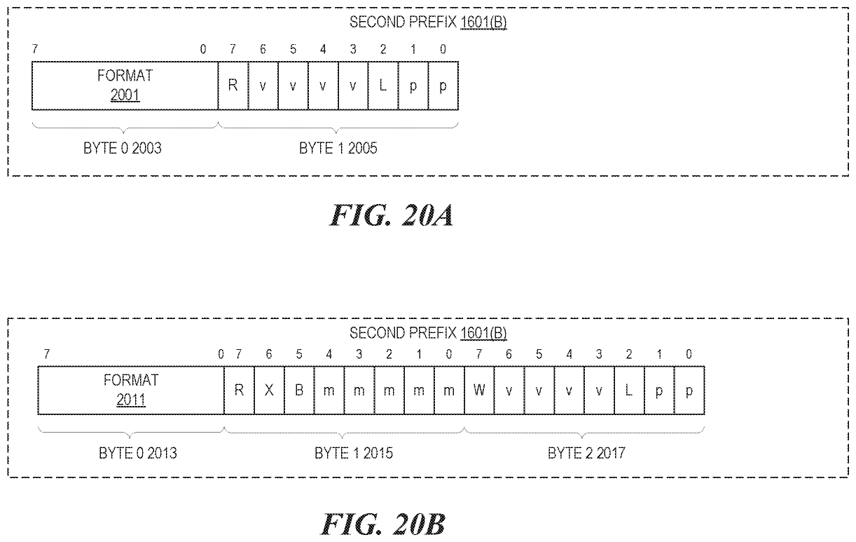

FIGS. 20(A)-(B) illustrate examples of a second prefix 1601(B). In some examples, the second prefix 1601(B) is an example of a VEX prefix. The second prefix 1601(B) encoding allows instructions to have more than two operands, and allows SIMD vector registers (e.g., vector/SIMD registers 1510) to be longer than 64-bits (e.g., 128-bit and 256-bit). The use of the second prefix 1601(B) provides for three-operand (or more) syntax. For example, previous two-operand instructions performed operations such as A=A+B, which overwrites a source operand. The use of the second prefix 1601(B) enables operands to perform nondestructive operations such as A=B+C.

In some examples, the second prefix 1601(B) comes in two forms—a two-byte form and a three-byte form. The two-byte second prefix 1601(B) is used mainly for 128-bit, scalar, and some 256-bit instructions; while the three-byte second prefix 1601(B) provides a compact replacement of the first prefix 1601(A) and 3-byte opcode instructions.

FIG. 20(A) illustrates examples of a two-byte form of the second prefix 1601(B). In one example, a format field 2001 (byte 0 2003) contains the value C5H. In one example, byte 1 2005 includes an “R” value in bit[7]. This value is the complement of the “R” value of the first prefix 1601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, vvvv, the MOD R/M R/M field 1746 and the MOD R/M reg field 1744 encode three of the four operands. Bits[7:4] of the immediate value field 1609 are then used to encode the third source register operand.

FIG. 20(B) illustrates examples of a three-byte form of the second prefix 1601(B). In one example, a format field 2011 (byte 0 2013) contains the value C4H. Byte 1 2015 includes in bits[7:5] “R,” “X,” and “B” which are the complements of the same values of the first prefix 1601(A). Bits[4:0] of byte 1 2015 (shown as mmmmm) include content to encode, as need, one or more implied leading opcode bytes. For example, 00001 implies a 0FH leading opcode, implies a 0F38H leading opcode, 00011 implies a 0F3AH leading opcode, etc.

Bit[7] of byte 2 2017 is used similar to W of the first prefix 1601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1746 to encode the instruction operand that references a memory address or encode either the destination register operand or a source register operand.

Instructions that use this prefix may use the MOD R/M reg field 1744 to encode either the destination register operand or a source register operand, or to be treated as an opcode extension and not used to encode any instruction operand.

For instruction syntax that support four operands, vvvv, the MOD R/M R/M field 1746, and the MOD R/M reg field 1744 encode three of the four operands. Bits[7:4] of the immediate value field 1609 are then used to encode the third source register operand.

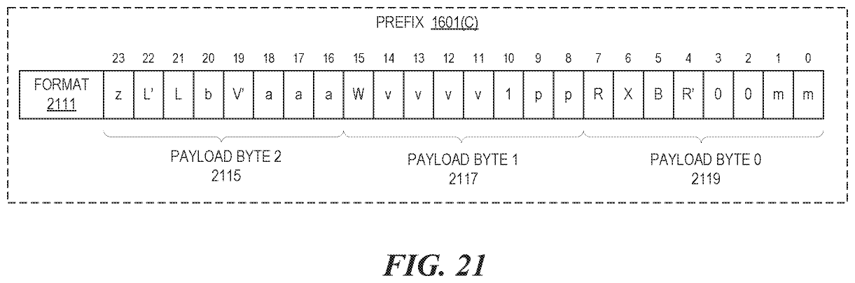

FIG. 21 illustrates examples of a third prefix 1601(C). In some examples, the third prefix 1601(C) is an example of an EVEX prefix. The third prefix 1601(C) is a four-byte prefix.

The third prefix 1601(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 15) or predication utilize this prefix. Opmask register allow for conditional processing or selection control. Opmask instructions, whose source/destination operands are opmask registers and treat the content of an opmask register as a single value, are encoded using the second prefix 1601(B).

The third prefix 1601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1601(C) is a format field 2111 that has a value, in one example, of 62H. Subsequent bytes are referred to as payload bytes 2115-2119 and collectively form a 24-bit value of P[23:0] providing specific capability in the form of one or more fields (detailed herein).

In some examples, P[1:0] of payload byte 2119 are identical to the low two mm bits. P[3:2] are reserved in some examples. Bit P[4] (R′) allows access to the high 16 vector register set when combined with P[7] and the MOD R/M reg field 1744. P[6] can also provide access to a high 16 vector register when SIB-type addressing is not needed. P [7:5] consist of R, X, and B which are operand specifier modifier bits for vector register, general purpose register, memory addressing and allow access to the next set of 8 registers beyond the low 8 registers when combined with the MOD R/M register field 1744 and MOD R/M R/M field 1746. P [9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P [15] is similar to W of the first prefix 1601(A) and second prefix 1611(B) and may serve as an opcode extension bit or operand size promotion.

P [18:16] specify the index of a register in the opmask (writemask) registers (e.g., writemask/predicate registers 1515). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P [14:11] to encode a second source vector register in a non-destructive source syntax which can access an upper 16 vector registers using P [19]. P [20] encodes multiple functionalities, which differs across different classes of instructions and can affect the meaning of the vector length/rounding control specifier field (P [22:21]). P [23] indicates support for merging-writemasking (e.g., when set to 0) or support for zeroing and merging-writemasking (e.g., when set to 1).

Example examples of encoding of registers in instructions using the third prefix 1601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or |
| | | | reg | | Source |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 22 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 22 shows a program in a high-level language 2202 may be compiled using a first ISA compiler 2204 to generate first ISA binary code 2206 that may be natively executed by a processor with at least one first ISA core 2216. The processor with at least one first ISA core 2216 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2204 represents a compiler that is operable to generate first ISA binary code 2206 (e.g., object code) that can, with or without additional linkage processing, be executed on the processor with at least one first ISA core 2216. Similarly, FIG. 22 shows the program in the high-level language 2202 may be compiled using an alternative ISA compiler 2208 to generate alternative ISA binary code 2210 that may be natively executed by a processor without a first ISA core 2214. The instruction converter 2212 is used to convert the first ISA binary code 2206 into code that may be natively executed by the processor without a first ISA core 2214. This converted code is not necessarily to be the same as the alternative ISA binary code 2210; however, the converted code will accomplish the general operation and be made up of instructions from the alternative ISA. Thus, the instruction converter 2212 represents software, firmware, hardware, or a combination thereof that, through emulation, simulation or any other process, allows a processor or other electronic device that does not have a first ISA processor or core to execute the first ISA binary code 2206.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus that includes a plurality of processing cores, a cache; and a cache controller. For these examples, the cache controller can be configured to receive an indication of whether data to be included in a cache line of the cache is likely to be reused. The cache controller can also be configured to set a priority bit for the data to be included in the cache line based on an indication that the data is likely to be reused. The cache controller can also be configured to set an age bit for the data to indicate an order of access for the cache line to store the data to the cache compared to at least one other cache line to be configured to separately store data to the cache, wherein the priority bit and the age bit are to be used to determine when to evict the data included in the cache line from the cache.

Example 2. The apparatus of example 1, the cache controller can be configured to determine when to evict the data based on an LRU cache replacement policy that causes the cache controller to evict the data from the cache when the priority bit and the age bit are separately decremented to a value of 0.

Example 3. The apparatus of example 1, wherein the data is likely to be reused based on use of the data in a hash join operation.

Example 4. The apparatus of example 3, the hash join operation can be a BroadcastHashjoin (BHJ) operation or can be a ShuffledHashjoin (SHJ) operation.

Example 5. The apparatus of example 3, the hash join operation can be associated with execution of an online analytical processing application workload by one or more processing cores from among the plurality of processing cores.

Example 6. The apparatus of example 1, the indication that the data is likely to be reused can be received in response to an ISA MOVREUSE instruction that can be used to load the data to the cache line and indicate that the data is likely to be reused.

Example 7. The apparatus of example 1, the cache can be an L2 cache or can be an L3 cache.

Example 8. An example at least one machine readable medium can include a plurality of instructions that in response to being executed by a cache controller of a processor cache, can cause the cache controller to receive an indication of whether data to be included in a cache line of the processor cache is likely to be reused. The instructions may also cause the cache controller to set a priority bit for the data to be included in the cache line based on an indication that the data is likely to be reused. The instructions may also cause the cache controller to set an age bit for the data to indicate an order of access for the cache line to store the data to the processor cache compared to at least one other cache line to be configured to separately store data to the processor cache, wherein the priority bit and the age bit are to be used to determine when to evict the data included in the cache line from the processor cache.

Example 9. The at least one machine readable medium of example 8, the instructions can further cause the cache controller to determine when to evict the data based on an LRU cache replacement policy that causes the cache controller to evict the data from the processor cache when the priority bit and the age bit are separately decremented to a value of 0.

Example 10. The at least one machine readable medium of example 8, the data to likely to be reused based on use of the data in a hash join operation.

Example 11. The at least one machine readable medium of example 10, the hash join operation can be a BroadcastHashjoin (BHJ) operation or can be a ShuffledHashjoin (SHJ) operation.

Example 12. The at least one machine readable medium of example 10, the hash join operation can be associated with execution of an online analytical processing application workload by one or more processing cores of a multi-core processor configured to use the processor cache.

Example 13. The at least one machine readable medium of example 8, the indication that the data is likely to be reused can be received in response to an ISA MOVREUSE instruction that is used to load the data to the cache line and indicate that the data is likely to be reused.

Example 14. The at least one machine readable medium of example 8, the processor cache can be an L2 cache or an L3 cache.

Example 15. An example method can include receiving, at a cache controller of a processor cache, an indication of whether data to be included in a cache line of the processor cache is likely to be reused. The method can also include setting a priority bit for the data to be included in the cache line based on an indication that the data is likely to be reused. The method can also include setting an age bit for the data to indicate an order of access for the cache line to store the data to the processor cache compared to at least one other cache line to be configured to separately store data to the processor cache, wherein the priority bit and the age bit are to be used to determine when to evict the data included in the cache line from the processor cache.

Example 16. The method of example 15 can also include determining when to evict the data based on an LRU cache replacement policy that causes the cache controller to evict the data from the processor cache when the priority bit and the age bit are separately decremented to a value of 0.

Example 17. The method of example 15, the data is likely to be reused based on use of the data in a hash join operation.

Example 18. The method of example 17, the hash join operation can be a BroadcastHashjoin (BHJ) operation or can be a ShuffledHashjoin (SHJ) operation.

Example 19. The method of example 17, the hash join operation can be associated with execution of an online analytical processing application workload by one or more processing cores of a multi-core processor configured to use the processor cache.

Example 20. The method of example 15, the indication that the data is likely to be reused can be received in response to an ISA MOVREUSE instruction that can be used to load the data to the cache line and indicate that the data is likely to be reused.

Example 21. The method of example 15, the processor cache can be anL2 cache or can be an L3 cache.

Example 22. An example at least one machine readable medium can include a plurality of instructions that in response to being executed by a system can cause the system to carry out a method according to any one of examples 15 to 21.

Example 23. An example apparatus can include means for performing the methods of any one of examples 15 to 21.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1.-23. (canceled)

24. An apparatus comprising:
a plurality of processing cores;
a cache; and
a cache controller configured to:
receive an indication of whether data to be included in a cache line of the cache is likely to be reused;
set a priority bit for the data to be included in the cache line based on an indication that the data is likely to be reused; and
set an age bit for the data to indicate an order of access for the cache line to store the data to the cache compared to at least one other cache line to be configured to separately store data to the cache, wherein the priority bit and the age bit are to be used to determine when to evict the data included in the cache line from the cache.

25. The apparatus of claim 24, wherein the cache controller is configured to determine when to evict the data based on a least recently used (LRU) cache replacement policy that causes the cache controller to evict the data from the cache when the priority bit and the age bit are separately decremented to a value of 0.

26. The apparatus of claim 24, wherein the data is likely to be reused based on use of the data in a hash join operation.

27. The apparatus of claim 26, wherein the hash join operation is a BroadcastHashjoin (BHJ) operation or a ShuffledHashjoin (SHJ) operation.

28. The apparatus of claim 26, wherein the hash join operation is associated with execution of an online analytical processing application workload by one or more processing cores from among the plurality of processing cores.

29. The apparatus of claim 24, wherein the indication that the data is likely to be reused is received in response to an instruction set architecture (ISA) MOVREUSE instruction that is used to load the data to the cache line and indicate that the data is likely to be reused.

30. The apparatus of claim 24, wherein the cache comprises level 2 (L2) cache or level 3 (L3) cache.

31. At least one machine readable medium comprising a plurality of instructions that in response to being executed by a cache controller of a processor cache, causes the cache controller to:
receive an indication of whether data to be included in a cache line of the processor cache is likely to be reused;
set a priority bit for the data to be included in the cache line based on an indication that the data is likely to be reused; and
set an age bit for the data to indicate an order of access for the cache line to store the data to the processor cache compared to at least one other cache line to be configured to separately store data to the processor cache, wherein the priority bit and the age bit are to be used to determine when to evict the data included in the cache line from the processor cache.

32. The at least one machine readable medium of claim 31, the instructions to further cause the cache controller to:
determine when to evict the data based on a least recently used (LRU) cache replacement policy that causes the cache controller to evict the data from the processor cache when the priority bit and the age bit are separately decremented to a value of 0.

33. The at least one machine readable medium of claim 31, wherein the data is likely to be reused based on use of the data in a hash join operation.

34. The at least one machine readable medium of claim 33, wherein the hash join operation is a BroadcastHashjoin (BHJ) operation or a ShuffledHashjoin (SHJ) operation.

35. The at least one machine readable medium of claim 33, wherein the hash join operation is associated with execution of an online analytical processing application workload by one or more processing cores of a multi-core processor configured to use the processor cache.

36. The at least one machine readable medium of claim 31, wherein the indication that the data is likely to be reused is received in response to an instruction set architecture (ISA) MOVREUSE instruction that is used to load the data to the cache line and indicate that the data is likely to be reused.

37. The at least one machine readable medium of claim 31, wherein the processor cache comprises level 2 (L2) cache or level 3 (L3) cache.

38. A method comprising:
receiving, at a cache controller of a processor cache, an indication of whether data to be included in a cache line of the processor cache is likely to be reused;
setting a priority bit for the data to be included in the cache line based on an indication that the data is likely to be reused; and
setting an age bit for the data to indicate an order of access for the cache line to store the data to the processor cache compared to at least one other cache line to be configured to separately store data to the processor cache, wherein the priority bit and the age bit are to be used to determine when to evict the data included in the cache line from the processor cache.

39. The method of claim 38, further comprising:
determining when to evict the data based on a least recently used (LRU) cache replacement policy that causes the cache controller to evict the data from the processor cache when the priority bit and the age bit are separately decremented to a value of 0.

40. The method of claim 38, wherein the data is likely to be reused based on use of the data in a hash join operation.

41. The method of claim 40, wherein the hash join operation is a BroadcastHashjoin (BHJ) operation or a ShuffledHashjoin (SHJ) operation.

42. The method of claim 40, wherein the hash join operation is associated with execution of an online analytical processing application workload by one or more processing cores of a multi-core processor configured to use the processor cache.

43. The method of claim 38, wherein the indication that the data is likely to be reused is received in response to an instruction set architecture (ISA) MOVREUSE instruction that is used to load the data to the cache line and indicate that the data is likely to be reused.
